(19) United States
(12) Patent Application Publication
(10) Pub. No.: US 2010/0275743 A1
(43) Pub. Date: Nov. 4, 2010

(54) TOOL END FOR IMPLANTABLE MEDICAL DEVICES

(75) Inventors: Eric J. Wengreen, Stanford, CA (US); Andrew J. Ries, Lino Lakes, MN (US); John E. Lovins, Oakdale, MN (US); Kathleen P. Macke, Hugo, MN (US); Randy S. Roles, Elk River, MN (US)

Correspondence Address: MEDTRONIC, INC., 710 MEDTRONIC PARKWAY NE, MINNEAPOLIS, MN, 55432-9924, US

(73) Assignee: Medtronic, Inc., Minneapolis, MN (US)

(21) Appl. No.: 12/771,860

(22) Filed: Apr. 30, 2010

Related U.S. Application Data
(60) Provisional application No. 61/256,790, filed on Oct. 30, 2009.
(60) Provisional application No. 61/174,431, filed on Apr. 30, 2009.

(51) Int. Cl. B25B 23/14

(52) U.S. Cl. 81/467

(57) ABSTRACT

A torque wrench for implantable medical devices is disclosed. The torque wrench comprises a handle, drive shaft member, and a torque wrench tool interface. The handle is coupled to the drive shaft member. The torque wrench tool end is coupled to the drive shaft member. The torque wrench tool end includes a plurality of prongs configured to engage an external tool end of a connector.

### CROSS-REFERENCE TO RELATED APPLICATIONS

This application claims the benefit of U.S. Provisional Application Nos. 61/256,790, filed on Oct. 30, 2009 and 61/174,431, filed on Apr. 30, 2009. The disclosure of the above applications are incorporated herein by reference.

### TECHNICAL FIELD

The present disclosure relates generally to wrenches, and, more particularly, to a torque wrench used to rotate a connector in an implantable medical device.

### BACKGROUND

Implantable medical devices (IMDs) such as pacemakers, defibrillators and neural stimulators can deliver therapy to tissue and/or sense various physiological parameters through medical leads. Leads include an elongated flexible lead body that has one or more insulated elongated conductors with one or more electrodes disposed at a distal end of the conductors.

Implanting an IMD or replacing an IMD typically entails connecting a lead to the IMD. To ensure the lead is properly secured to an IMD, the proximal end of each conductor, referred to as a terminal pin, is passed through a conductor bore in a connector block of a header. A setscrew, which passes through a threaded setscrew bore that intersects with the conductor bore, is positioned to contact the conductor. A torque wrench is then used to apply a certain amount of torque to the setscrew. Torque applied to the setscrew should provide a retention force between the setscrew and the conductor that is sufficiently large to prevent the conductor from dislodging from the header yet low enough to prevent the torque from potentially damaging the setscrew or conductor. It is desirable to develop a torque wrench tool end that can displace tissue that may have grown over and around the setscrew's external tool end while still enabling a secure fit between the torque wrench and the setscrew.

### BRIEF DESCRIPTION OF THE DRAWINGS

The following drawings are illustrative of particular embodiments of the present disclosure and therefore do not limit the scope of the disclosure. The drawings are not to scale (unless so stated) and are intended for use in conjunction with the explanations in the following detailed description. Embodiments of the present disclosure will hereinafter be described in conjunction with the appended drawings, wherein like numerals denote like elements.

FIG. 1 depicts a schematic view of an exemplary implantable medical device system that has medical electrical leads;

FIG. 2 depicts a schematic view of a user turning an exemplary torque wrench to rotate a setscrew located inside an implantable medical device;

FIG. 3 depicts a schematic cutaway view of the header of FIG. 1 taken along lines 3-3;

FIG. 4 is a schematic exterior view of an exemplary torque wrench;

FIG. 5A depicts a schematic view of a torque wrench tool end prior to contacting a connector;

FIG. 5B depicts a schematic view of a torque wrench tool end connected to a connector;

FIG. 5C depicts a schematic top view of a tool end of FIG. 5A taken along lines C-C;

FIG. 6A depicts a schematic view of a torque wrench tool end separated from a connector;

FIG. 6B depicts a schematic view of an enlarged drive shaft with a tool end as shown in FIG. 6A;

FIG. 7A depicts a drive shaft and a tool end with a set of prongs;

FIG. 7B depicts a drive shaft and tool end with a set of prongs;

FIG. 8 is a schematic exterior view of another exemplary torque wrench;

FIG. 9A depicts a side view of a tool end for the torque wrench depicted in FIG. 8;

FIG. 9B depicts a side view of a tool end for the torque wrench depicted in FIG. 8;

FIG. 10 is a schematic exterior view of another exemplary torque wrench;

FIG. 11 depicts a side view of a plurality of protruding ends on a tool end for the torque wrench depicted in FIG. 10;

FIG. 12 depicts a side view of a tool end for the torque wrench depicted in FIG. 10 in which protruding ends are shown as moving from a starting position to a flexed position;

FIG. 13 depicts an angled view of a first and second groove defined by protruding ends of a tool end for the torque wrench depicted in FIG. 10;

FIG. 14 depicts a top view of a first and second groove defined by protruding ends of a tool end for the torque wrench depicted in FIG. 10;

FIG. 15 depicts a perspective view of a first and second groove defined by protruding ends for the torque wrench depicted in FIG. 10;

FIG. 16 depicts a perspective view of a drive shaft with a tool end;

FIG. 17A depicts a perspective view of one plane of the drive shaft shown in FIG. 16;

FIG. 17B depicts a top perspective view of a first and second groove of a tool end of FIG. 17A taken along lines B-B;

FIG. 17C depicts a top perspective view of an end to tool end of FIG. 17A taken along lines A-A;

FIG. 18A depicts a perspective view of another plane that opposes the plane of the drive shaft shown in FIG. 17A;

FIG. 18B depicts a perspective view of an end of the drive shaft shown in FIG. 17A taken along lines D-D;

FIG. 18C depicts a perspective view of a chamfered end of the drive shaft shown in FIG. 17A taken along lines A-A;

FIG. 18D depicts a perspective view of a second groove formed in a tool end of FIG. 17A taken along lines B-B;

FIG. 18E depicts a perspective view of a first groove and a second groove formed in a tool end of FIG. 17A taken along lines B-B;

FIG. 19 depicts a perspective view of a connector;

FIG. 20 depicts a perspective view of a connector in a header;

FIG. 21 depicts an enlarged perspective view of a connector in a header;

FIG. 22 depicts a perspective view of a tissue displacement channel near the first and second grooves of a tool end;

FIG. 23 is a schematic exterior view of another exemplary torque wrench connected to setscrew; and

FIG. 24 is an enlarged view of a tool end for the torque wrench depicted in

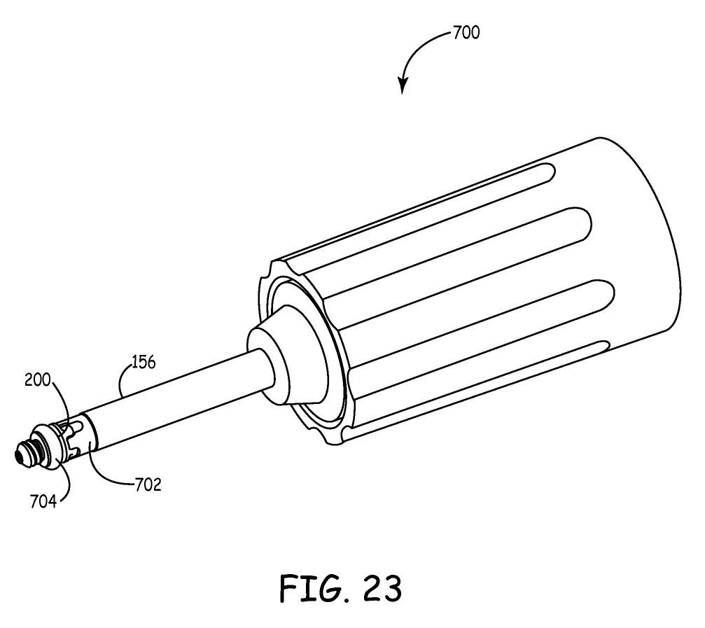

FIG. 23.

### DETAILED DESCRIPTION

The following description is merely exemplary in nature and is not intended to limit the present disclosure, application, or uses. One will understand that the components, including number and kind, may be varied without altering the scope of the disclosure. Also, devices according to various embodiments may be used in any appropriate diagnostic or treatment procedure, including a cardiac procedure.

A torque wrench for implantable medical devices is disclosed. The torque wrench comprises a handle, a drive shaft member, and a torque wrench tool end. The torque wrench tool end includes a plurality of prongs configured to quickly and securely engage or mate with an external tool end of a connector such as a setscrew. Setscrews connect to a terminal pin of an elongated conductor, a ring or other suitable components. Tissue maybe displaced through a connector bore of a header due to tissue overgrowth around the connector's external tool end during the time period in which the setscrew was chronically implanted in a person.

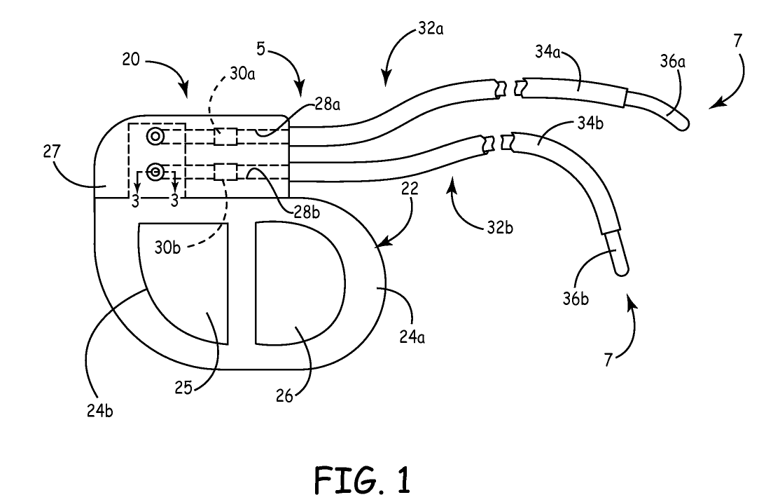

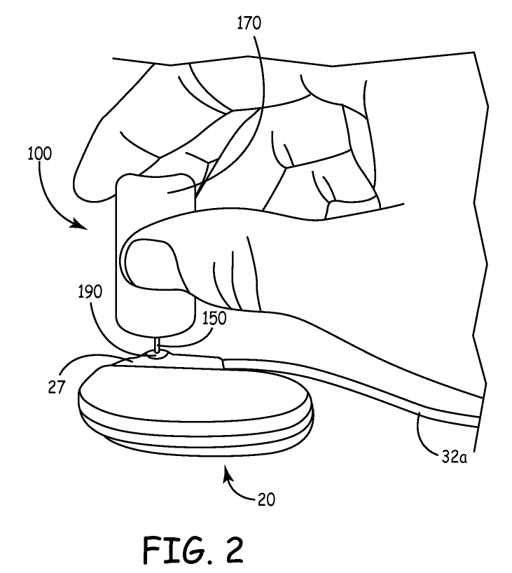

Referring to FIGS. 1-2, an implantable medical device (IMD) 20 can include implantable pacemakers, implantable cardioverter defibrillator (ICD) devices, cardiac resynchronization therapy defibrillator devices, neurostimulators, drug pumps or combinations thereof. Exemplary IMDs are commercially available as including one generally known to those skilled in the art, such as the Medtronic CONCERTO™, SENSIA™, VIRTUOSO™, RESTORE™, RESTORE ULTRA™, sold by Medtronic, Inc. of Minnesota. IMD 20 can include an implantable case, housing or body assembly 22. Implantable case 22 can be formed of appropriate materials and include appropriate features, such as a hermetically sealed body wall 24a. Body wall 24a comprises substantially conductive material such as titanium.

Contained within or associated with case 22 can be a power device 25 such as one or more batteries and/or capacitors encased in housing or case body wall 24b, a controller assembly 26, and a connector body 27. Controller assembly 26 can include a circuit board having a processor, memory, transmitter, receiver, and/or other appropriate portions. Connector body 27 can extend from or be integrated with case 22. At its distal end, connector body 27 can include one or more ports 28a,b that interconnects with one or more connector terminals 30a,b of one or more medical electrical lead assemblies 32a,b. Exemplary connector bodies 27 can include International Standard-1 (IS-1) connectors, IS-4 connectors or other suitable connectors contained within an insulative body, referred to as a header.

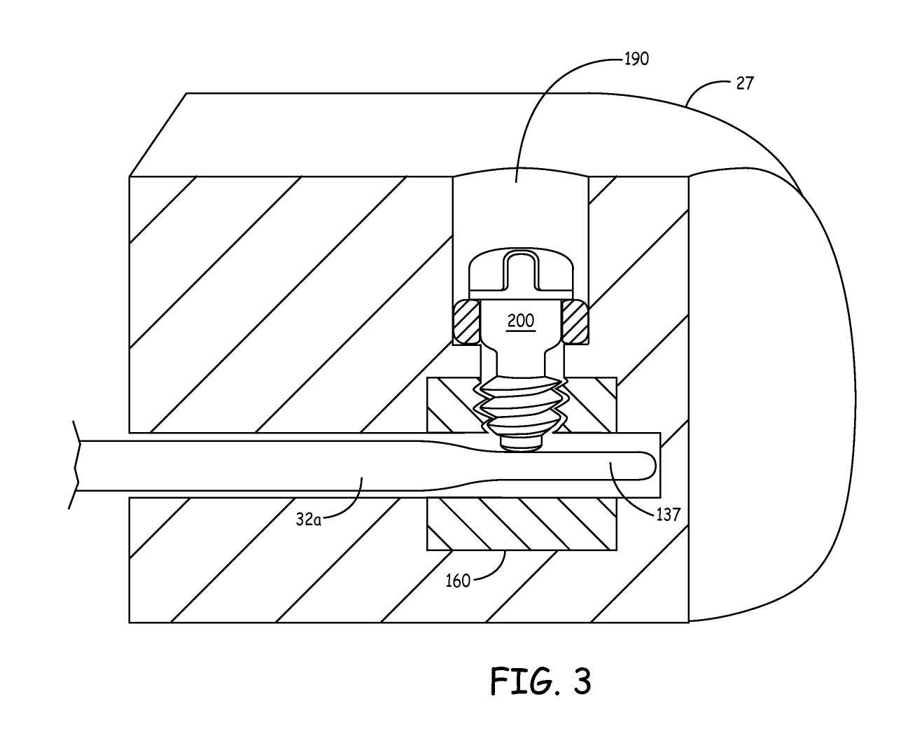

Lead assemblies 32a,b can comprise respective lead bodies 34a,b. Lead bodies 34a,b include one or more elongated insulated electrically conductive elements or conductors. Each conductive element extends from a proximal end 5 to a distal end 7. In particular, as shown in FIG. 3, an elongated conductive element or conductor for the lead assemblies 32a,b has a terminal pin 137 located at its proximal end 5 and, at the distal end 7, an uninsulated portion of a conductive element connects with one of the electrodes such as a ring electrode or a tip electrode 36a,b.

To connect a lead body 34a,b to the IMD 20, the terminal pin 137, which extends from lead body 34a,b, is placed through a bore in connector body 27 and inside a setscrew block 160. A torque wrench 300 enters connector bore 190 to contact the connector 200. An exemplary torque wrench 300 for applying an appropriate amount of torque to connector 200 is depicted in FIG. 4. Torque wrench 300 can comprise, or consist of, a handle 170 and a drive shaft member 150 which are used, in combination, to tighten connector 200 onto a terminal pin 137. The torque wrench handle 170 can rotate the drive shaft member 150, which, in turn, rotates connector 200 until connector 200 is sufficiently tightened against terminal pin 137, as depicted in FIGS. 2-3. Connector 200 is a setscrew with an external drive tool end but connector 200 can also be a nut, bolt or other suitable connector with an external drive tool interface.

The torque wrench 300, depicted in FIG. 4, has a first end 282 and a second end 280. A tool end 220 is connected to or integrally formed at the first end 282 of torque wrench 300. A torque wrench longitudinal rotational axis 250 passes through the center of the torque wrench 300 and extends from the tool end 220 to the distal end 280. A portion or all of drive shaft member 150 can extend inside the interior portion of the handle 170. A portion of the drive shaft member 150, referred to as the drive shaft 156, can extend outside the handle 170. Drive shaft 156 can be flush with handle 170. Alternatively, drive shaft 156 can partially or totally extend away from the handle 170. An example of a torque wrench that may implement the teachings disclosed herein may be seen with respect to U.S. Application Serial Number 12/533,975 filed on Jul. 31, 2009, and assigned to the assignee of the present invention, the disclosure of which is incorporated by reference in its entirety herein.

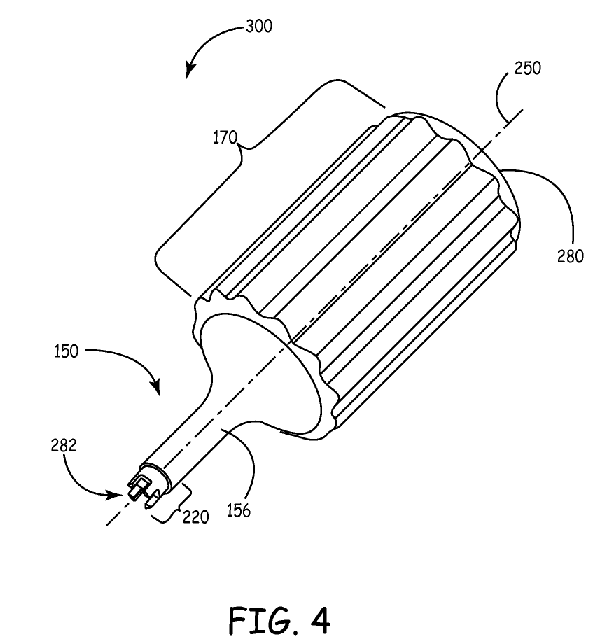

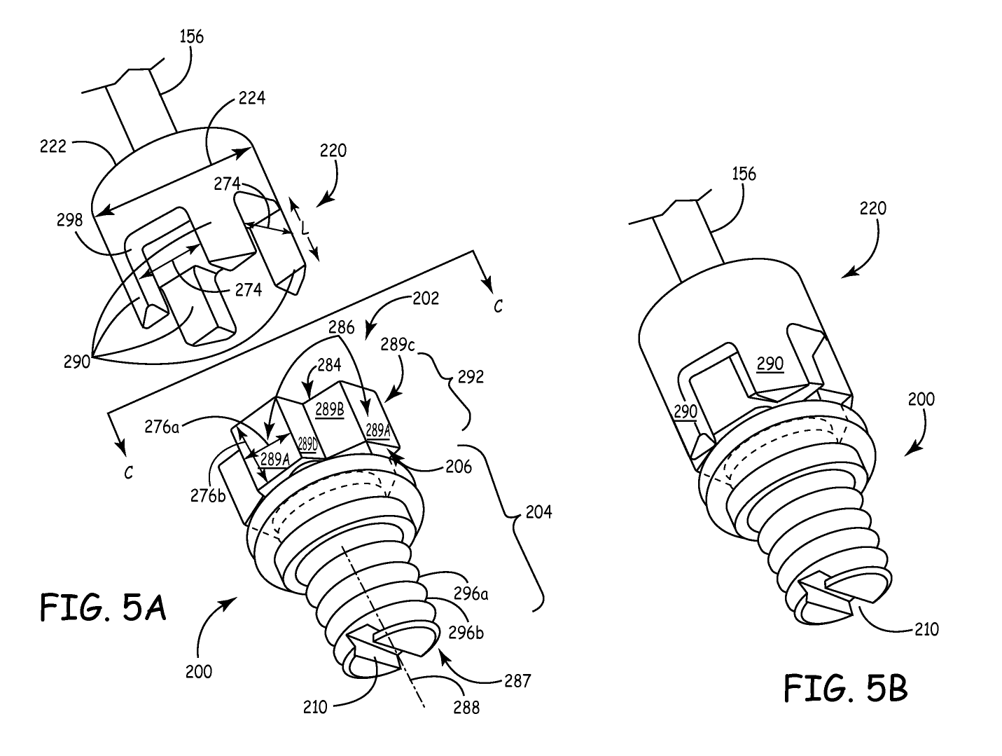

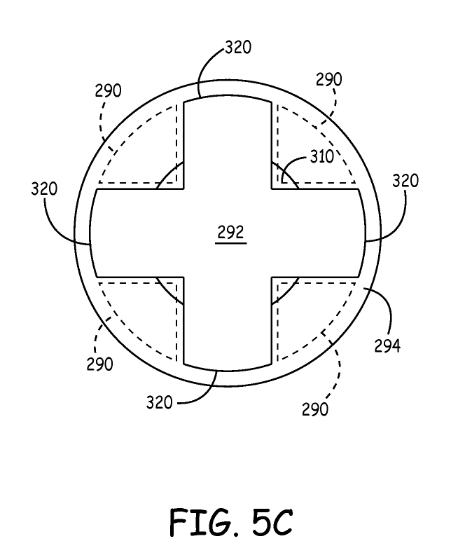

FIG. 5A depicts an exemplary torque wrench tool end 220 prior to engaging with a setscrew 200. Tool end 220 can comprise a base 222, prongs or protruding ends 290, and gaps 274 or indented portions therebetween. Two or more prongs or protruding ends 290 are integrally formed from base 222. Protruding ends 290 extend away from the perimeter of base 222.

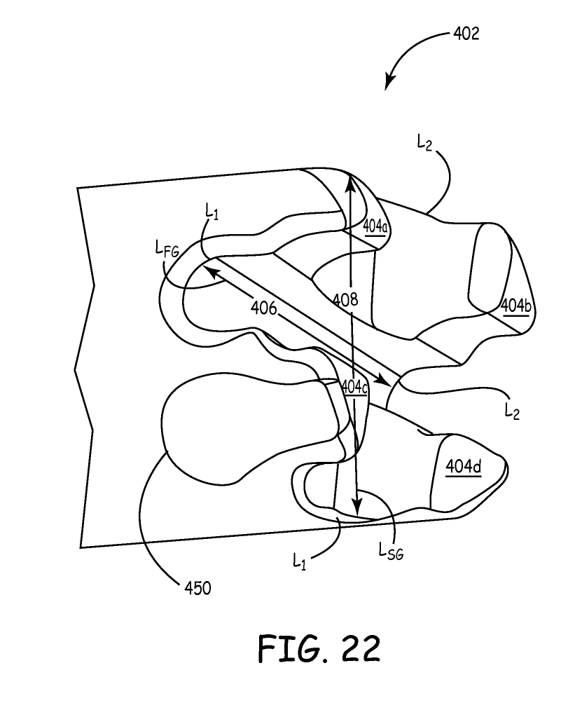

In one or more embodiments, each gap 274, interleaved between each protruding end 290, is sized about equal to the width of connector end 286 of setscrew 200. Referring briefly to FIG. 22, the width of the connector end 286 can range from Wₛ₁-Wₛ₃. The four protruding ends 290, shown in FIG. 5A, can be elongated and substantially triangular shaped. For example, each protruding end 290 can have a length L from base 222.

Setscrew 200 or fastener can include a setscrew head 292 or fastener head integrally formed to threaded body 204. Setscrew head 292 is configured to engage tool end 220 (also referred to as an external drive tool end 220). As shown, setscrew head 292 can be cross-shaped, substantially cross-shaped or any other suitable shape. In one or more embodiments, the setscrew head 292 has a top surface 202, an external perimeter 295, and a bottom surface 206. The external perimeter 295 can include two or more ends 286 or blocks that extend or protrude perpendicular from longitudinal rotational axis 250.

In one or more embodiments, connector ends 286 can extend in a substantial perpendicular direction up to 45 degrees)(°) from the thread axis 288. For example, connector end 286 can be +/−90°, +/−80°, +/−70°, etc. in a perpendicular direction from thread axis 288. Ends 286 are block-shaped. Each end 286 can have a rectangular shape, a substantial rectangular shape, a square shape, a triangular shape, a substantial triangular shape or other suitable shapes.

Connector end 286 can include faces 289a-c. Each face 289a-c can be sized the same having a width 276a and length 276b. Alternatively, two or more faces 289a-c can have a different size and/or shape than other faces 289a-c. Faces 289a-c are aligned or substantially aligned with the thread axis 288 (also referred to as a first longitudinal axis) which runs through the center of the setscrew 200 from the threaded end 287 of the setscrew 200 through to the top surface 202 of setscrew head 292. Substantially aligned occurs when faces 289a-c are aligned within 30 degrees with the thread axis 288.

Threaded body 204 extends a distance D_{T} from a center of the bottom surface 206 of setscrew head 292, which is near end 287. Each thread 296a can be separated from another thread 296b by a certain distance. Slot or groove 210 is configured to connect to a terminal pin 137 on a lead assembly 32, as shown in FIG. 2.

FIG. 5B depict tool end 220 connected to setscrew 200. A gap 284 or indented portion is located between each connector end 286 such that connector ends 286 of the setscrew 200 are able to snugly fit into each gap 274 of tool end 220 to form an interference fit between setscrew 200 and tool end 220. Additionally, ends 290 of tool end 220 fit into each gap 284 of setscrew 200, which forms an engagement configuration as shown in FIG. 5B. When mating with tool end 220, connector ends 286 can extend through gap 274 or be flush with the wall 298 of gap 274. In a fully engaged position with setscrew 200, prongs 290 can displace tissue that has grown around the setscrew head 292 while the IMD 20 was implanted. The prongs 290 can push the tissue out of the indented portions 286 of the setscrew head 292 and allow the tissue to flow out of the connector bore 190 of FIG. 2. The edges of the prongs 290 can be rounded to reduce the likelihood of gouging and/or scraping of the setscrew head 292.

FIG. 5C provides greater details of a top view of protruding ends 290 with a cross-shaped polymeric seal 294 disposed between and around prongs 290. Polymeric seal 294 also partially covers a neck 310 of the sealing setscrew 200. The neck 310 connects the tool end 220 portion of the setscrew to the exposed metal insert portion of the setscrew 200.

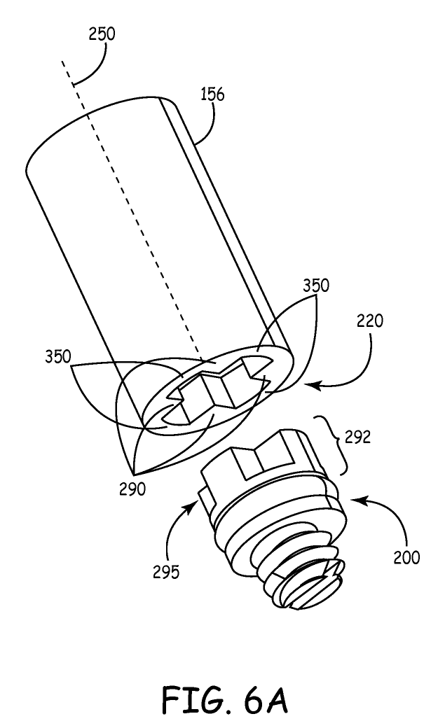

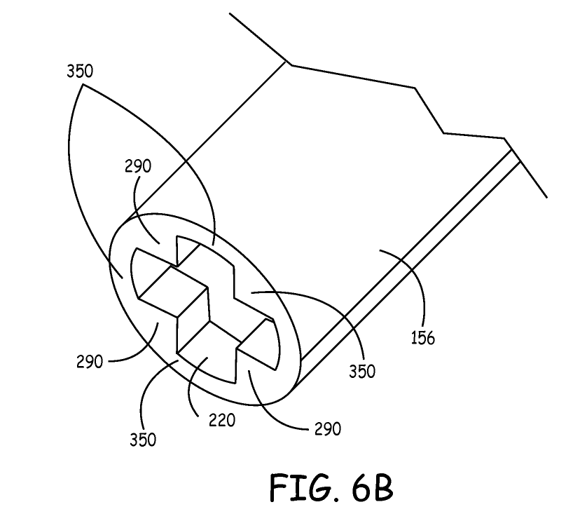

FIGS. 6A-6B show yet another exemplary torque wrench tool end 220 that can be used with a torque wrench such as torque wrench 300. Optionally, tool end 220 can include a web 350 that can protect a seal (e.g. o-ring seal etc.) used to electrically isolate electrodes (e.g. tip electrode 36a,b, ring electrode 38a,b etc.) from tissue from potential torque wrench-induced damage. Web 350 can be a thin polymeric hoop that connects the outer perimeter of the prongs 290 of the torque wrench tool end 220. The outer perimeter of the prongs 290 consists of the outer surfaces 320 of the prongs 290 that face directly away from the torque wrench rotational axis 250. The web 350 typically increases the strength of prongs 290. In one or more embodiments, the thickness of the web 350 ranges from about 0.005 inches to about 0.020 inches. In one or more embodiments, the thickness of the web 350 is 0.003 to 0.075 inches. In one or more embodiments, the thickness of the web 350 is 0.001 to 0.2 inches. The width of the tool end 220 is smaller when a web 350 is not present compared to when a web 350 is present.

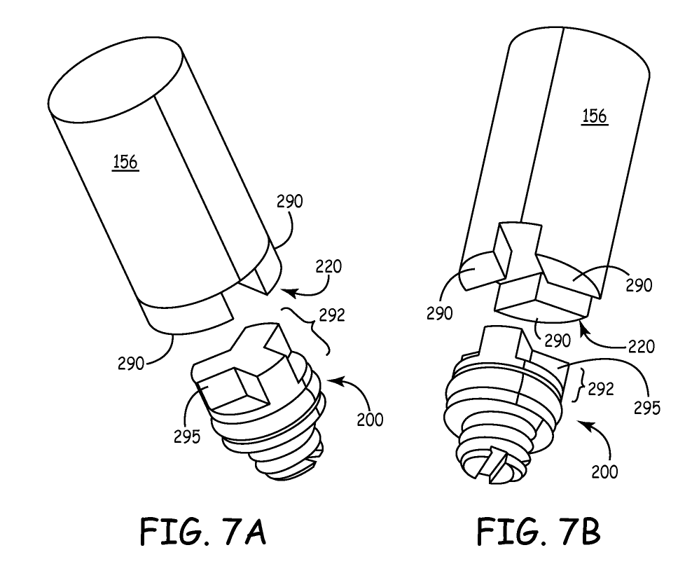

In other embodiments, the torque wrench tool end 220 has two to ten prongs. For example, FIGS. 7A-7B show a torque wrench tool end 220 with three prongs 290 that can be used with torque wrench 300. In this embodiment, the three prongs 290 are Y-shaped.

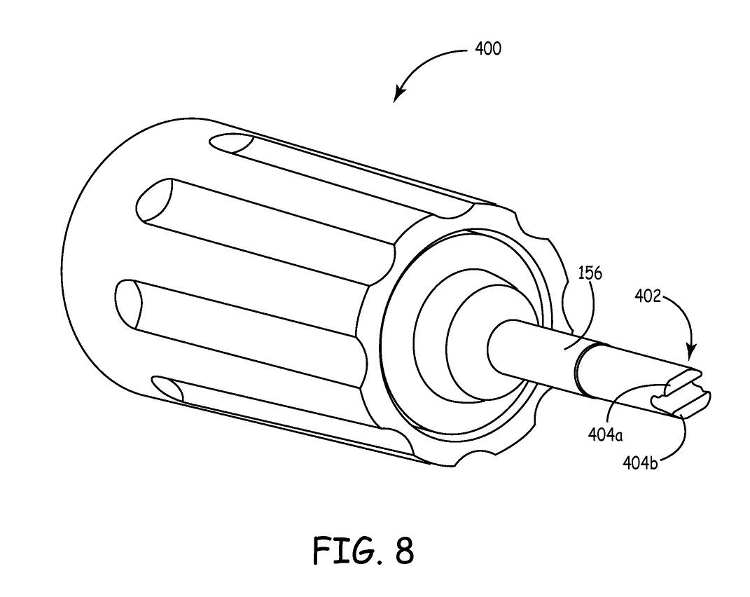

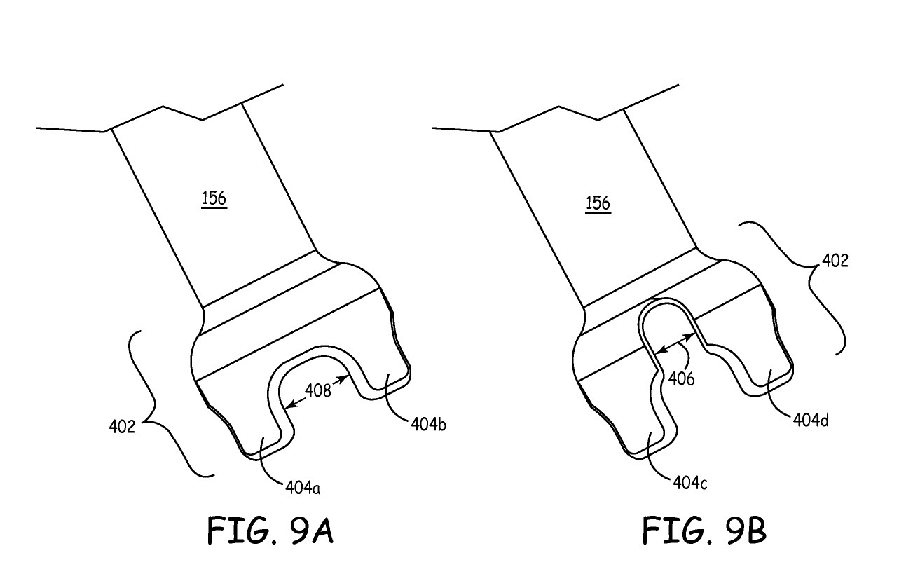

FIG. 8 depicts yet another exemplary embodiment of a torque wrench 400. Torque wrench 400 is the same as torque wrench 300 except drive shaft 156 includes a tool end 402, shown in greater detail in FIGS. 9A-9B, that is configured to include protruding ends 404a,b with a groove 410 or slot disposed therebetween. Protruding ends 404a,b or parallel segments can flex apart to enable an interference fit with an external indented perimeter 295 of the setscrew head 292. Setscrew head 292 can include a groove that is configured to receive protruding ends 404a,b. Alternatively, protruding ends 404a,b can be inserted into individual recessed regions in setscrew head 292 in which the recessed regions are sized to fit protruding ends 404a,b. An interference fit between set screw 200 and tool end 402 can occur when the gap 274 is smaller than the face width 276. For example, gap 274 is smaller than face width 276 when the tool end 402 is relaxed or exhibits a certain amount of flexibility. Protruding ends 404a,b can be parallel or substantially parallel. Substantially parallel can occur when the angle between the each protruding end 404a-d is less than about 30 degrees. In another embodiment, the tool end 220 has more than one slot. In yet another embodiment, the prongs 290 are more than 20 percent longer than the portion of setscrew head 292 that engages the prongs 290 to enable the prongs 290 extra length to elastically deform to enable an interference fit.

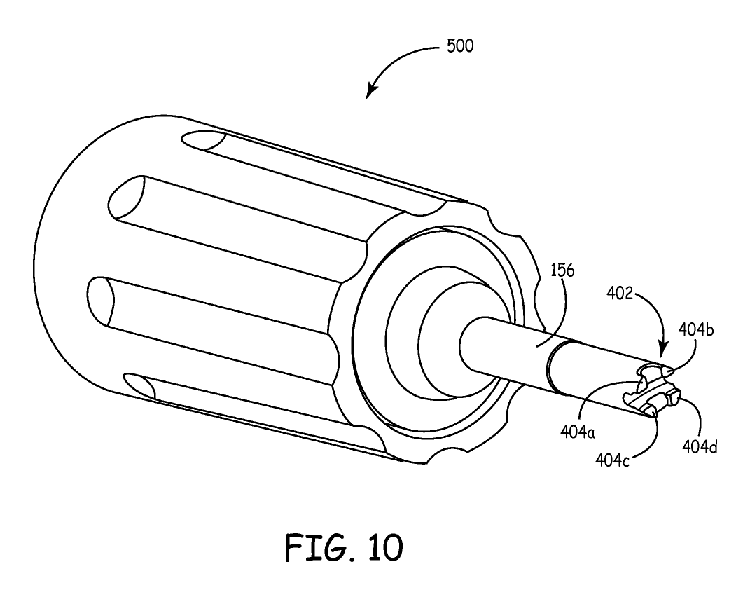

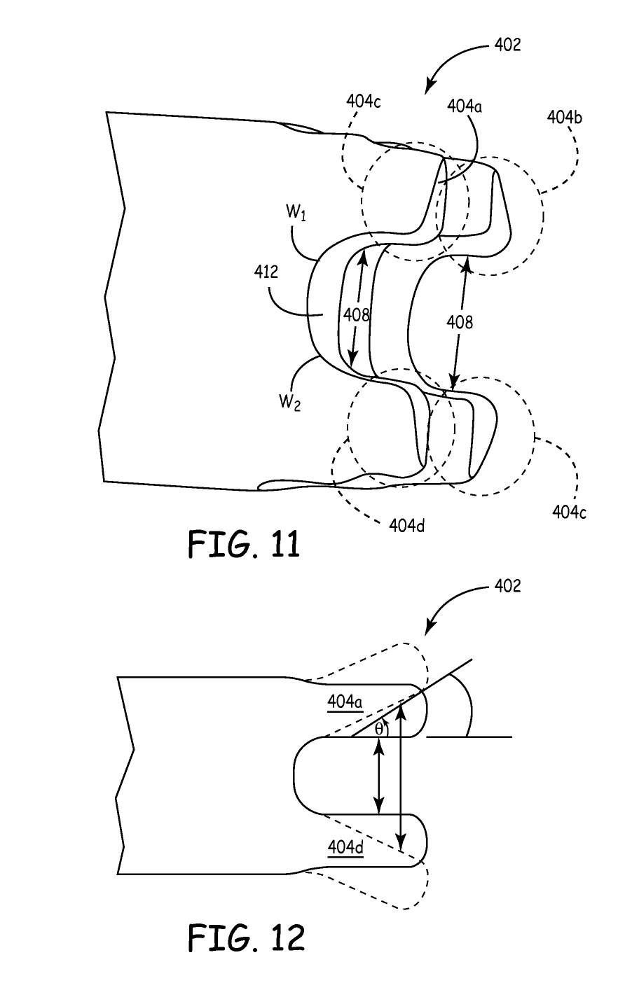

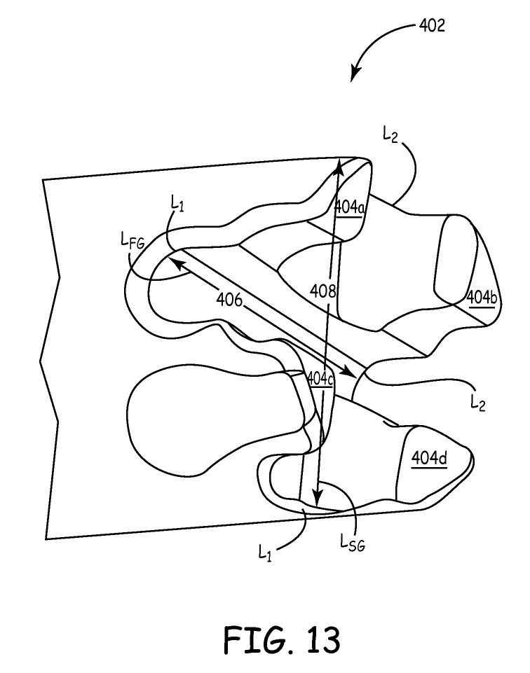

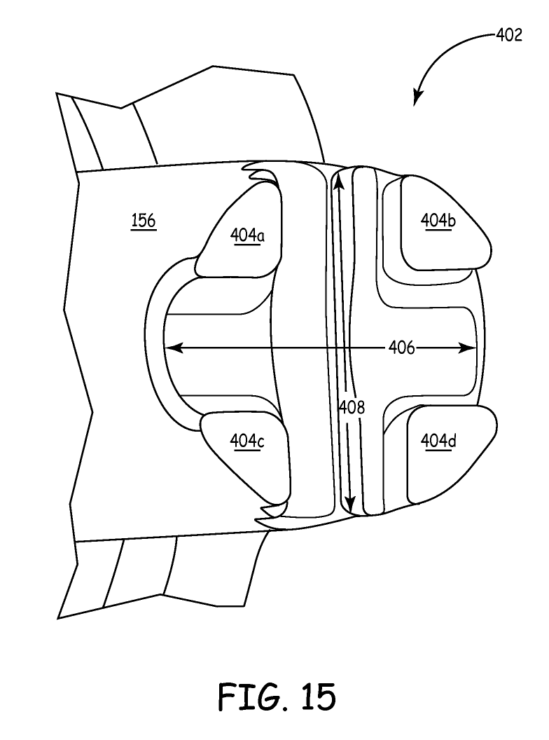

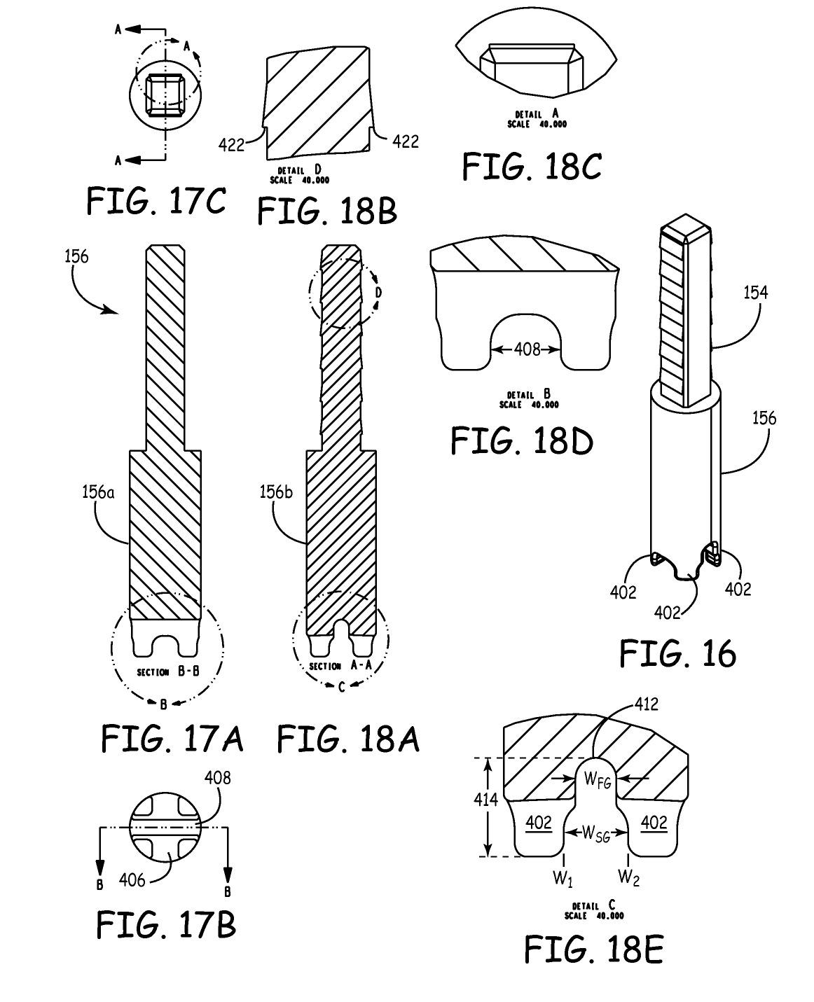

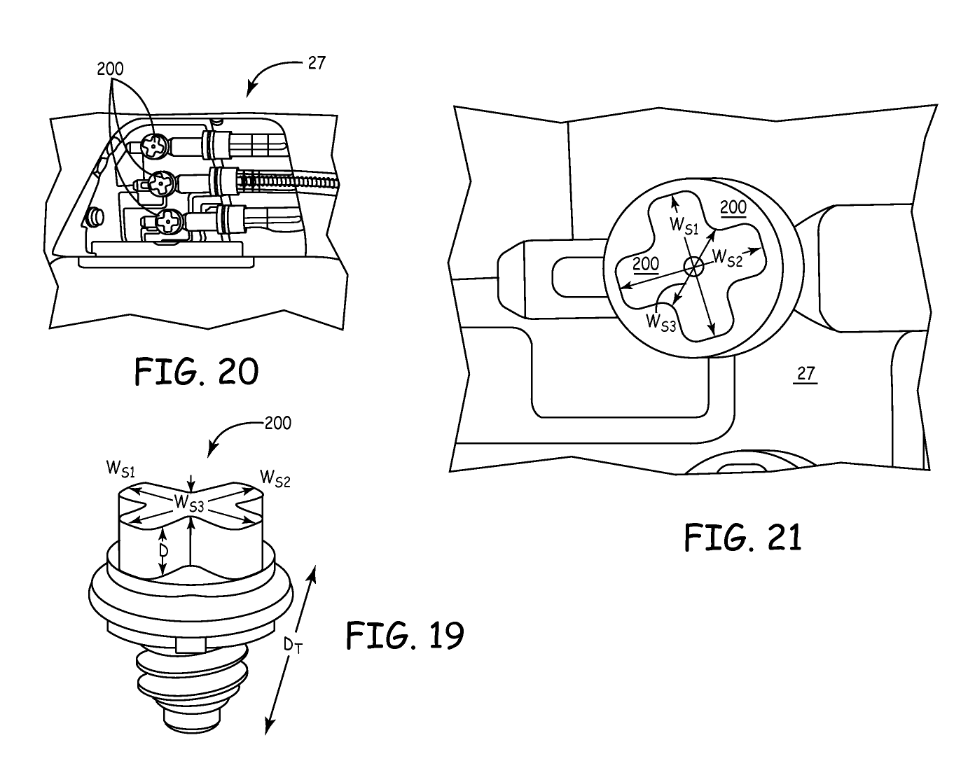

FIG. 10 depicts yet another exemplary embodiment of a torque wrench 500. Torque wrench 500 is the same as torque wrench 300 except drive shaft 156 includes a mating receptacle 154 to connect drive shaft 156 and tool end 402 using hinged ends 422, as shown in FIG. 16, and FIG. 18B, respectively. Tool end 402 is configured with protruding ends 404a-d which form a first and a second groove 406, 408 respectively disposed therebetween, as shown in greater detail in FIGS. 11-18. First groove 406 can have a depth that extends from a surface 412 to a depth 414. First groove 406 can have a certain depth.

Second groove 408 overlaps first groove 406. In one or more embodiments, second groove 408 overlaps between the center of first and second grooves 406, 408. Second groove 408 can have a surface 416 to a depth 418. Second groove 408 can have a length L_{SG} that ranges from L1 to L2 and a W_{SG}.

Protruding ends 404a-d or parallel segments can flex apart to enable an interference fit with an external indented perimeter 295 of the setscrew head 292. For example, as shown in FIG. 12, protruding ends 404a,d can flex to a flex position shown in ghost lines up to a flex angle θ. Protruding ends 404a,d can move from a starting distance to a flex distance of L_{flex distance}. The flex angle θ can have a certain range. In one or more embodiments, L_{flex distance} can range up to about 10 percent of the starting distance. In one or more embodiments, L_{flex distance} can range from about 10 percent of the starting distance to about 20 percent of the starting distance. In one or more embodiments, L_{flex distance} can range from up to 50 percent of the starting distance.

An interference fit occurs when the gap 274 is smaller than the face width 276 when the tool end 402 is relaxed. Protruding ends 404a-d can be parallel or substantially parallel. Substantially parallel can occur when the angle between each protruding end 404a-d is less than about 30 degrees. In yet another embodiment, the prongs 402 are more than 20 percent longer than a portion of the setscrew head 292 that engages the prongs 402 to enable the prongs 402 extra length to elastically deform to enable an interference fit. For example, setscrew 200 connector ends 286 fit within first and second grooves 406 and 408. In particular, one end of connector end 286 passes the depth of the second groove 408 and fits against the inner wall of the first groove 406. Once the tool end 402 of a torque wrench has mated with the setscrew 200, sufficient torque is applied until the set screw is properly tightened down on setscrew 200. Tool end 402 then releases setscrew 200 and torque wrench is disposed of by the physician.

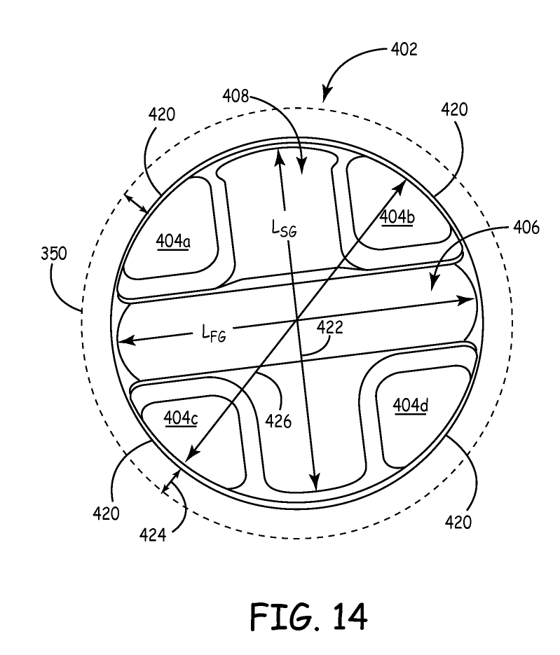

In an alternative embodiment, FIG. 14 depicts tool end 402 that can include a web 350 that can protect a seal from potential wrench-induced damage. Web 350 can be a thin polymeric hoop that connects the outer perimeter of the prongs 290 of the torque wrench tool end 220. The outer perimeter of the prongs 290 consists of the outer surfaces 420 of the prongs 290 that face directly away from the torque wrench rotational axis 250. The web 350 typically increases the strength of prongs 290. In one or more embodiments, the thickness of the web 350 ranges from about 0.005 inches to about 0.020 inches. In one or more embodiments, the thickness of the web 350 is 0.003 to 0.075 inches. In one or more embodiments, the thickness of the web 350 is 0.001 to 0.2 inches. The width 426 of the tool end 220 is smaller when a web 350 is not present compared to when a web 350 is present. For example, web 350 increases width 426 by a width 424.

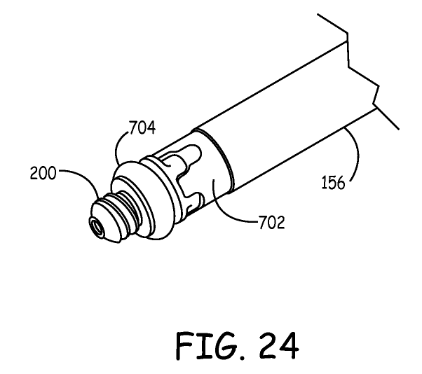

FIGS. 23-24 is another exemplary torque wrench 700. As depicted, torque wrench 700 is connected to setscrew 200. Torque wrench 700 includes drive shaft 156 with a tool end 702 disposed on one end of drive shaft 156. Torque wrench 700 can include first and second grooves that intersect each other in a cross-shaped fashion. In one embodiment, the first and second grooves have the same depth measured from the groove surface to the tip of each prong. In another embodiment, the first and second grooves have a different depth measured from the groove surface to the tip of each prong.

Torque wrenches 300-500 can be formed using a variety of materials and techniques. For example, the drive shaft member 150 and/or handle 170 can consist of a polymeric material such as polyetherimide (PEI), although many polymers could be used such as polyaryletheretherketone (PEEK) or acrylonitrile butadiene styrene (ABS). The drive shaft member 150 and/or the handle 170 can be molded. In other embodiments, the drive shaft member 150 can consist of or comprise a metal material such as stainless steel 316. The drive shaft member 150 and/or the handle 170 can be machined. In a preferred embodiment, the prongs 290 are metal such as stainless steel 316 to ensure adequate mechanical strength.

Although the present disclosure has been described in considerable detail with reference to certain disclosed embodiments, the disclosed embodiments are presented for purposes of illustration and not limitation and other embodiments of the disclosure are possible. For example, while the tool end itself can be configured as a female connector to connect with a setscrew head configured as a male connector, it is appreciated that the tool end can be configured as a male member while the setscrew head is configured as a female connector. Additionally, drive shaft with a tool end can be separately produced and coupled to conventional torque wrench. It is to be appreciated that another engagement configuration relative to FIGS. 5A-5B relates to only a portion of each prong 290 residing in a portion of the external indented perimeter 295 that juts inward towards the setscrew's 200 thread axis. In one or more embodiments, an interfering fit between a tool end and a fastener (e.g. setscrew) can be unique to the two sides formed by the set of prongs. For example, a stiff set of prongs has less interference and more stability than a set of flexible prongs with a larger groove. Groove depth can be adjusted to match the desired fit based on the materials chosen for the prongs.

Moreover, skilled artisans will appreciate that while exemplary dimensions are presented relative to specified elements, other dimensions can be used to implement the teachings presented herein. It will be appreciated that various changes, adaptations, and modifications may be made without departing from the spirit of the disclosure and the scope of the appended claims.

What is claimed is:

1. An instrument comprising:
a torque wrench for use with an implantable medical device, the torque wrench comprising:
a handle coupled to a drive shaft member; and
a torque wrench tool end disposed at one end of the drive shaft member, the torque wrench tool end comprises a set of prongs which define a first groove and a second groove, the second groove has a greater depth from a prong tip than a depth from a first groove to a prong tip.

2. The instrument of claim 1, wherein each prong is flexible.

3. The instrument of claim 1, wherein each prong has a tapered tip.

4. The instrument of claim 1, wherein each prong can have a flat tip.

5. The instrument of claim 1, wherein each prong is elongated with rounded edges.

6. The instrument of claim 1, further comprising a second groove and the first groove intersect.

7. The instrument of claim 1, wherein the set of prongs includes at least two prongs.

8. The instrument of claim 1, wherein the set of prongs includes three prongs.

9. The instrument of claim 1, wherein the set of prongs includes four prongs.

10. The instrument of claim 1, wherein a polymeric web connects at least a partial external perimeter of the set of prongs.

11. The instrument of claim 1, wherein a web comprising a metal connects at least a partially external perimeter of the set of prongs.

12. The instrument of claim 1, wherein a slideable web over the top of the set of prongs connects a partial external perimeter of the set of prongs.

13. The instrument of claim 10, wherein the first and the second grooves form a cross-shape configuration.

14. The instrument of claim 1, wherein the set of prongs flexibly spread apart to enable an interference fit with an external tool end of a connector.

15. The instrument of claim 1, wherein each prong flexibly bend without breaking.

16. The instrument of claim 1, wherein the torque wrench tool end includes a tissue displacement valley.

17. The instrument of claim 16, wherein a depth of tissue displacement valley is based upon at least one of tissue displacement efficacy and strength of each prong.

18. An instrument comprising:
a torque wrench for use with an implantable medical device, the torque wrench comprising:
a handle coupled to a drive shaft member; and
a torque wrench tool end disposed at one end of the drive shaft member, the torque wrench tool end comprises a set of prongs that provide an interfering friction fit between the set of prongs and a head of the mating fastener.

19. The instrument of claim 18, wherein the torque wrench tool end a depth of a groove can exceed the depth required to fit over a head of a screw with additional relief for the interfering friction fit.

20. The instrument of claim 18, wherein the set of prongs define a first groove and a second groove, the second groove has a greater depth from a prong tip than a depth from a first groove to a prong tip.

21. The instrument of claim 18, wherein the set of prongs define a first groove and a second groove, the second groove has about a same depth from a prong tip as a depth from a first groove to a prong tip.

22. An instrument comprising:
a torque wrench for use with an implantable medical device, the torque wrench comprising:
a handle coupled to a drive shaft member; and
a torque wrench tool end disposed at one end of the drive shaft member, the torque wrench tool end comprises a first set of prongs and a second set of prongs that provide an interfering friction fit between the set of prongs and a head of the mating fastener.

23. The instrument of claim 22, wherein the first set of prongs are more flexible than the second set of prongs.

24. The instrument of claim 22, wherein the second set of prongs are stiffer than the first set of prongs, the second set of prongs having less interference and more stability than the first set of prongs.

25. The instrument of claim 22, wherein a groove depth is adjustable to match an interference fit with a fastener.
